(19) United States
(12) Patent Application Publication
(10) Pub. No.: US 2013/0099919 A1
(43) Pub. Date: Apr. 25, 2013

(54) EMERGENCY GUIDING SYSTEM AND SERVER

(71) Applicants: Yi-Wen CAI, Tu-Cheng (TW); Shih-Cheng WANG, Tu-Cheng (TW)

(72) Inventors: Yi-Wen CAI, Tu-Cheng (TW); Shih-Cheng WANG, Tu-Cheng (TW)

(73) Assignee: HON HAI PRECISION INDUSTRY CO., LTD., Tu-Cheng (TW)

(21) Appl. No.: 13/278,114

(22) Filed: Oct. 20, 2011

(51) Int. Cl. G08B 1/08

(52) U.S. Cl. 340/539.13

(57) ABSTRACT

An emergency guiding system includes an emergency guiding server, a portable device, and short distance wireless identifiers. The emergency guiding server includes a guiding scheme determination unit producing a guiding scheme in response to an emergency and a route providing unit producing a recommended route according to the last guiding scheme and a location signal in response to the production of the guiding scheme. The short distance wireless identifiers detect the presence of the portable device through a short distance wireless communication unit of the portable device, thereby transmitting the corresponding location signal to the emergency guiding server. The emergency guiding server transmits a guiding signal to the portable device according to the location signal, wherein the guiding signal includes a portion of a recommended route adjacent to the portable device to reach a particular target. The disclosure further provides an emergency guiding server.

### BACKGROUND

1. Technical Field

The present disclosure relates to an emergency guiding system and an emergency guiding server, and particularly to an emergency guiding system and an emergency guiding server having evacuation guidance through portable devices.

2. Description of Related Art

In a conventional emergency guiding system, evacuation guidance is provided through devices often immovably disposed along the evacuation pathway. In an emergency, evacuation guidance is provided through the devices such as indicator lights or speakers. However, in dense smoke, the indicator lights may not be seen and thus will not be able to act as guides for evacuees. In addition, other factors such as the layout and the density of the devices will influence evacuation guidance.

What is needed, therefore, is an emergency guiding system capable of overcoming the limitation described.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an emergency guiding system of the present disclosure.

FIG. 2A is a schematic view of an embodiment of the layout of the short distance wireless identifiers of the emergency guiding system of FIG. 1 on a floor plan.

FIG. 2B is a schematic view of another embodiment of the layout of the short distance wireless identifiers of the emergency guiding system of FIG. 1 on a floor plan.

FIGS. 3A, 3B, and 3C are schematic views of an embodiment of displaying a route chart through the portable device of the emergency guiding system of FIG. 1.

FIG. 4 is a schematic view of another embodiment of displaying a route chart through the portable device of the emergency guiding system of FIG. 1.

FIG. 5 is a schematic view of an embodiment of displaying a warning message through the portable device of the emergency guiding system of FIG. 1.

### DETAILED DESCRIPTION

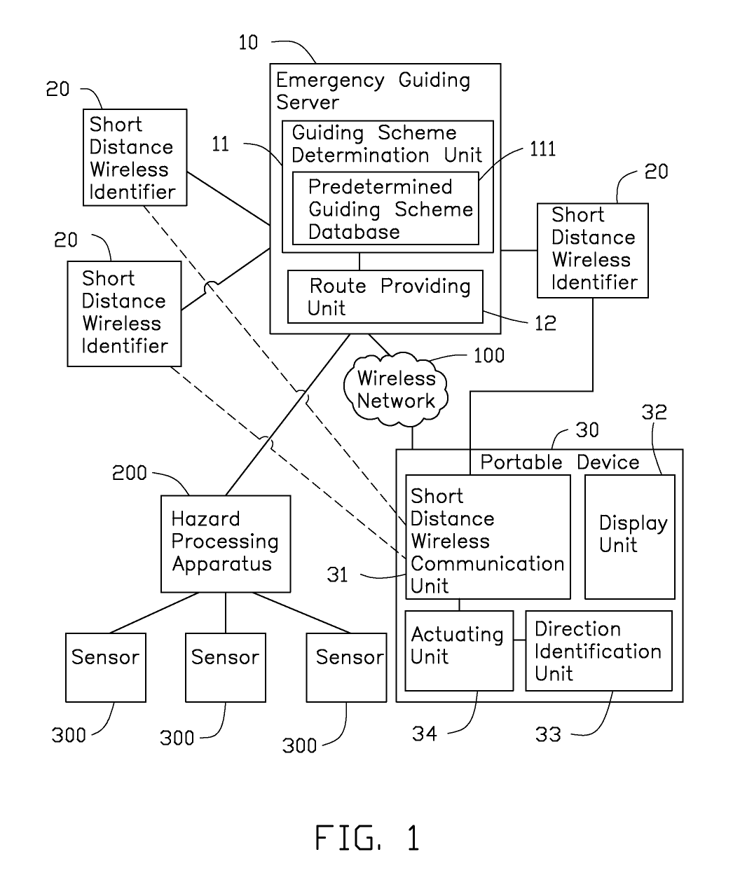

FIG. 1 is a block diagram of an embodiment of an emergency guiding system of the present disclosure. As shown in FIG. 1, an emergency guiding system includes an emergency guiding server 10, short distance wireless identifiers 20, and a portable device 30. In the illustrated embodiment, the emergency guiding system is applied to the emergency guiding of a fire hazard. In other embodiments, the emergency guiding system can be applied to other types of emergencies such as illegal entry.

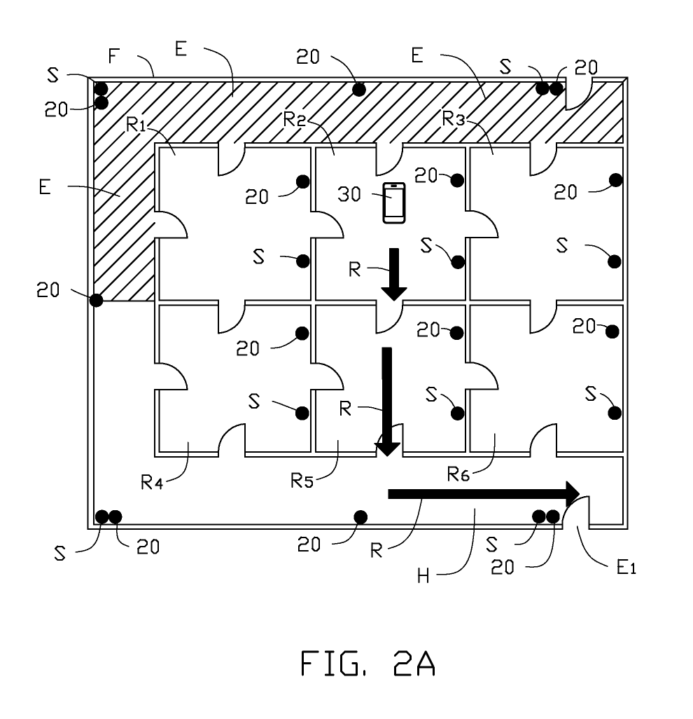

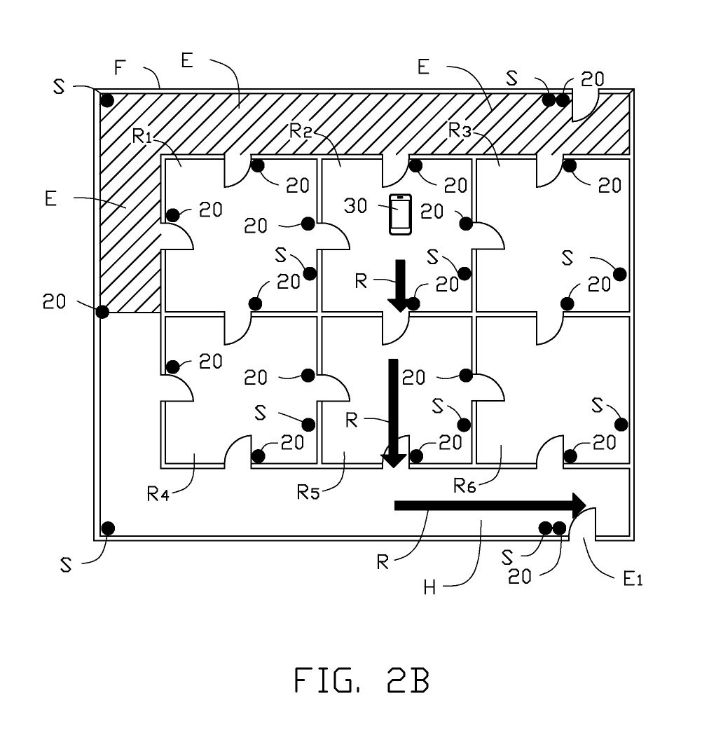

The emergency guiding server 10 includes a guiding scheme determination unit 11 and a route providing unit 12. The guiding scheme determination unit 11 produces a guiding scheme G (not shown) in response to the current status of an emergency area E in an emergency (see FIG. 2A) such as a fire hazard or an illegal entry in real time. The route providing unit 12 produces a recommended route R (see FIG. 2A) to reach a particular target such as an exit, a place, or a fire apparatus in response to the production of the guiding scheme G. The recommended route R is produced according to the last guiding scheme G and a location signal S₁ received from the short distance wireless identifier 20 which represents the presence of the portable device 30. The emergency guiding server 10 communicates with the portable device 30 through a wireless network 100 and the short distance wireless identifier 20. The wireless network 100 is implemented according to a telecommunication standard such as Wi-Fi, Bluetooth, and GSM (Global System for Mobile Communications). The emergency guiding server 10 transmits a guiding signal S_{g} including a portion of the recommended route R adjacent to the portable device 30 to the portable device 30 according to the location signal S₁. The emergency guiding server 10 transmits the guiding signal S_{g} via the wireless network 100.

The emergency guiding server 10 is alerted to the emergency in the emergency area E by an alarm signal Sₐ received from a hazard processing apparatus 200 which is coupled to a plurality of sensors 300. In the illustrated embodiment, the hazard processing apparatus 200 is a fire alarm control panel. The hazard processing apparatus 200 transmits the alarm signal Sₐ including status information I (not shown) of the actuated sensors 300 to the emergency guiding server 10 when the current status of the emergency in emergency area E is detected by the sensors 300. The guiding scheme determination unit 11 includes a predetermined guiding scheme database 111 including predetermined guiding schemes Gₚ (not shown) corresponding to the sensors 300. The predetermined guiding schemes Gₚ are guiding schemes determined in advance, which determined according to the status of the sensors 300 such as the location, the type, the detected parameters, and the actuation time of the sensors 300. Each of the predetermined guiding schemes Gₚ includes various sets of the status of the sensors 300 which are essential conditions in choosing the schemes, and the recommended route R. In other embodiments, the predetermined guiding schemes Gₚ can include the location of other objects related to the emergency such as fire apparatus. The guiding scheme determination unit 11 chooses one of the predetermined guiding schemes Gₚ as the guiding scheme G according to the status information I of the actuated sensors 300 in the alarm signal Sₐ. In other embodiments, the guiding scheme determination unit 11 can determine the guiding scheme G by other methods such as using a guiding scheme determination algorithm, instead of using the predetermined guiding scheme database 111. In addition, the emergency guiding server 10 can receive the alarm signal Sₐ directly from the sensors 300. Since the emergency guiding server 10 is alerted to the emergency by the alarm signal Sₐ which represents the real time status of the emergency in the emergency area E, the recommended route R can be produced in a dynamic manner and updated corresponding to the real time status of the emergency.

The short distance wireless identifiers 20 detect the presence of the portable device 30, thereby transmitting the corresponding location signal S₁ to the emergency guiding server 10. In the illustrated embodiment, the location signal S₁ includes a location of the portable device 30. In other embodiments, the location signal S₁ can include a location of the short distance wireless identifier 20, or other parameters of the portable device 30 and the short distance wireless identifier 20. In addition, the location of the portable device 30 can be determined through the location signals S₁ received from a plurality of the short distance wireless identifiers 20. FIG. 2A is a schematic view of an embodiment of the layout of the short distance wireless identifiers of the emergency guiding system of FIG. 1 on a floor plan. In the illustrated embodiment, as shown in FIG. 2A, the short distance wireless identifiers 20 are distributed over a floor plan F such that the portable device 30 can be detected at any corner of the floor plan F, wherein the floor plan F including rooms R₁ to R₆ is a scene of the emergency. In other embodiments, the short distance wireless identifiers 20 can be disposed in other types of spaces such as a room, a hallway, a carriage of a vehicle, or a cabin of a ship, and can be disposed in other manners so as to correspond to actual demands. FIG. 2B is a schematic view of another embodiment of the layout of the short distance wireless identifiers of the emergency guiding system of FIG. 1 on a floor plan. As shown in FIG. 2B, the short distance wireless identifiers 20 can be disposed corresponding to each exit of the floor plan F, such that the portable device 30 can be detected when the portable device 30 gets through any of the exits. As shown in FIG. 2A/2B, sensor icons S represent the sensors 300 disposed on the floor plan F. The scope with respect to the emergency, which is detected by the sensors 300 represented as the sensor icons S, is marked. The recommended route R to an exit E₁ is represented by arrows.

The portable device 30 includes a short distance wireless communication unit 31, a display unit 32, a direction identification unit 33, and an actuating unit 34. In the illustrated embodiment, the portable device 30 is a smart phone. In other embodiments, the portable device 30 can be other types of portable electronic devices such as feature phone, tablet computer, or notebook computer. The short distance wireless identifiers 20 communicate with the portable device 30 through the short distance wireless communication unit 31, thereby detecting the presence of the portable device 30. In the illustrated embodiment, the short distance wireless communication unit 31 is a Bluetooth transmitter. Correspondingly, the short distance wireless identifiers 20 are Bluetooth receivers. In other embodiments, the short distance wireless communication unit 31 and the short distance wireless identifiers 20 can be other types of devices implemented according to other types of telecommunication standards. For example, the short distance wireless communication unit 31 and the short distance wireless identifiers 20 can be an RFID (radio-frequency identification) tag and RFID readers, respectively. In addition, the short distance wireless communication unit 31 and the short distance wireless identifiers 20 can be a transmitter and receivers of near field communication (NFC), respectively.

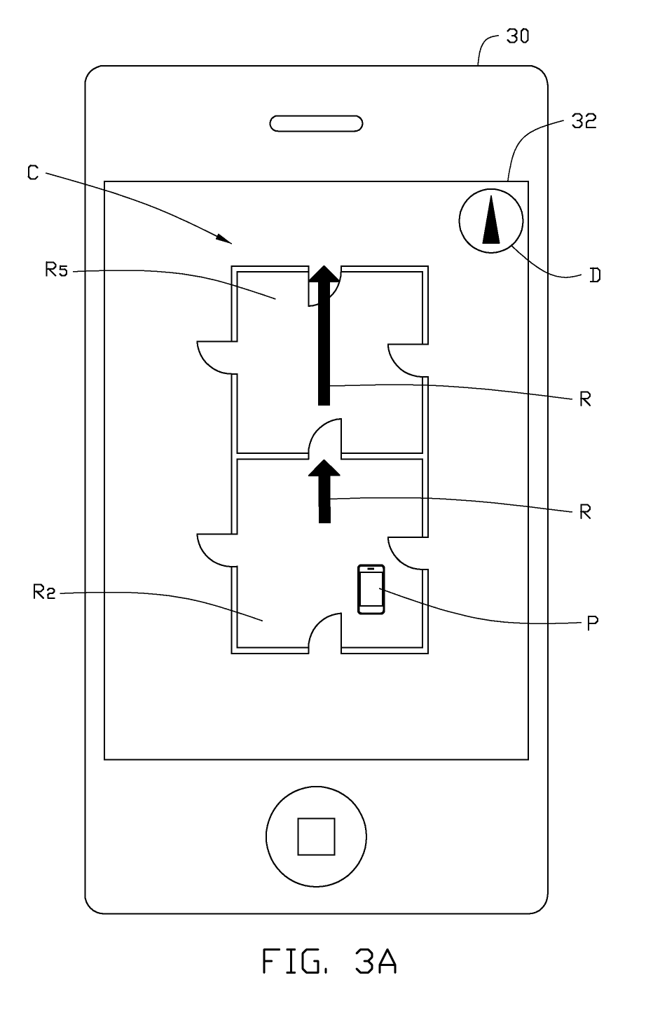

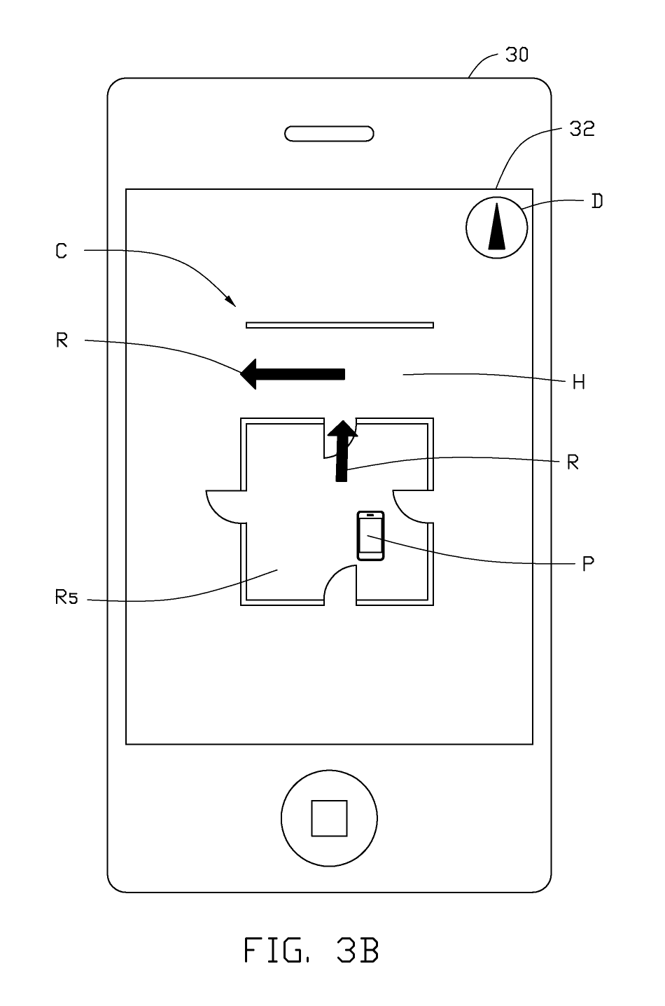

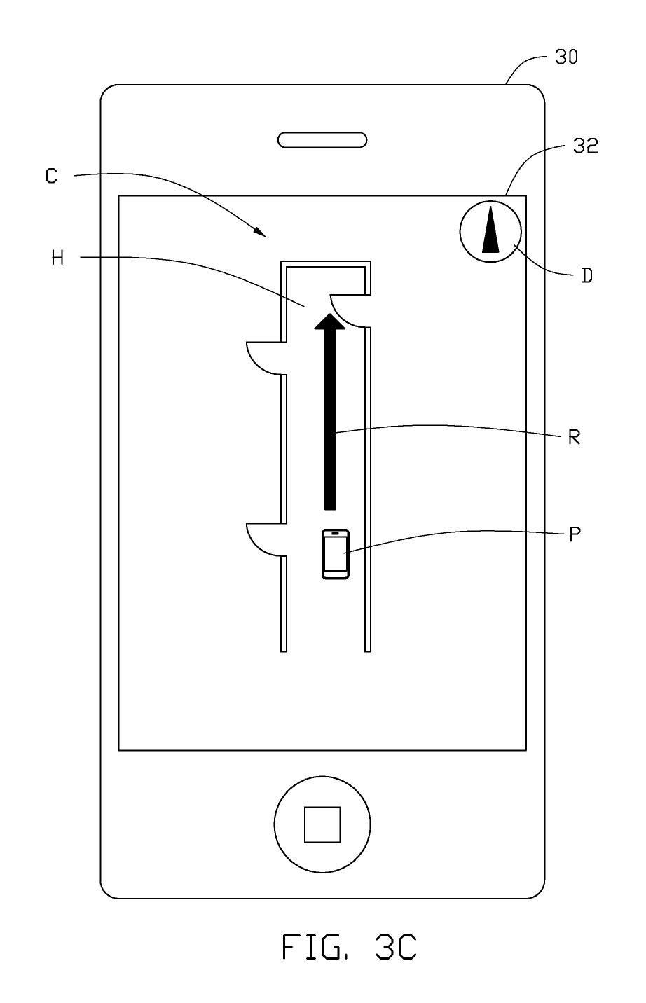

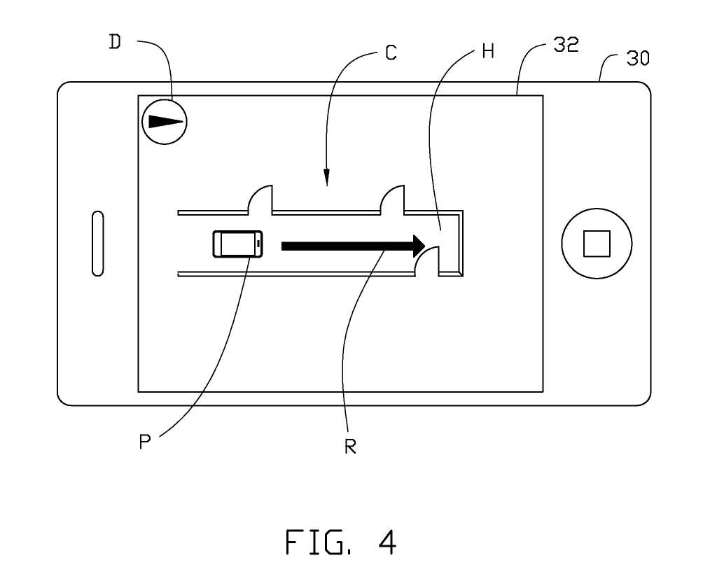

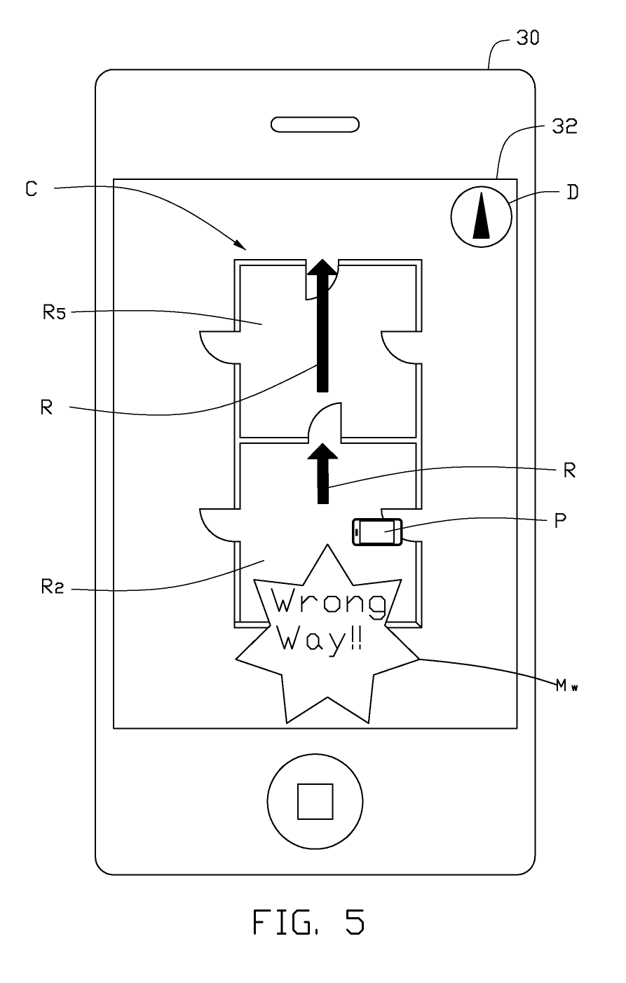

In the illustrated embodiment, the display unit 32 displays a route chart C (see FIG. 3A) including the portion of the recommended route R adjacent to the portable device 30 and a portable device icon P representing the location and the direction of the portable device 20, wherein the route chart C is produced according to the portion of the recommended route R in the guiding signal S_{g}. In other embodiments, the route chart C can be produced by the route providing unit 12 of the emergency guiding server 10, while the guiding signal S_{g} includes the route chart C instead of merely including the recommended route R. The range of the portion of the recommended route R displayed by the display unit 32 can be adjusted according to actual demands by, for instance, finger translation gestures with respect to the route chart C displayed on the display unit 32, thereby transmitting a route range signal Sᵣ to the emergency guiding server 10. The emergency guiding server 10 adjusts the range of the recommended route R (including the boundary and the detail of the recommended route R) transmitted to the portable device 30 according to the route range signal Sᵣ. The direction identification unit 33 determines a direction of the portable device 30. The direction identification unit 33 is a device such as electronic compass and magnetometer which is capable of determining Earth's magnetic field. FIGS. 3A, 3B, and 3C are schematic views of an embodiment of displaying a route chart through the portable device of the emergency guiding system of FIG. 1. In the illustrated embodiment, as shown in FIGS. 3A, 3B, and 3C, the route chart C automatically rotates corresponding to the direction of the portable device 30, such that the direction to evacuate corresponds to the top side of the display unit 32. As shown in FIG. 3A, the route chart C displayed by the display unit 32 includes a portion of the recommended route R which is one unit of space adjacent to the portable device 30. Since the portable device 20, represented as the portable device icon P is in the room R₂, the route chart C includes a portion of the recommended route R which is in the room R₂ and the room R₅ adjacent to the room R₂. As shown in FIG. 3B, the portable device icon P is in the room R₅, so the route chart C includes a portion of the recommended route R which is in the room R₅ and a hallway H adjacent to the room R₅. As shown in FIG. 3C, the portable device icon P is in the hallway H, so the route chart C includes a portion of the recommended route R which is in the hallway H. In other embodiments, the direction of the route chart can be fixed to a particular direction corresponding to the scene of the emergency. FIG. 4 is a schematic view of another embodiment of displaying a route chart through the portable device of the emergency guiding system of FIG. 1. As shown in FIG. 4, when the direction of the portable device 30 in FIG. 3A is turned counterclockwise, the direction of the route chart C is still corresponding to the actual direction of the scene of the emergency while that of the portable device icon P is also turned counterclockwise. In addition, as shown in FIGS. 3A, 3B, 3C, and 4, the display unit 32 further displays an indicator D to indicate the direction to evacuate according to the recommended route R. The display of the route chart C and the indicator D can be selectively enabled/disabled. FIG. 5 is a schematic view of an embodiment of displaying a warning message through the portable device of the emergency guiding system of FIG. 1. As shown in FIG. 5, the display unit 32 of the portable device 30 displays a warning message M_{w}, when the way which the portable device 30 moves not corresponds to the recommended route R in the guiding signal S_{g}.

In the illustrated embodiment, the actuating unit 34 such as an application software automatically enables the short distance wireless communication unit 31 and the direction identification unit 33 in response to a triggering signal Sₜ received from the emergency guiding server 10, wherein the emergency guiding server 10 produces the triggering signal Sₜ in response to the emergency. In other embodiments, the actuating unit 34 can automatically enable/disable other components of the portable device 30 which are necessary for the operation of the emergency guiding system. In addition, the portable device 30 can include a speaker unit such as phone speaker or loudspeaker, thereby providing audio guidance according to the recommended route R in the guiding signal S_{g}. The audio guidance can be provided through, for example, a phone call to drive the speaker unit.

The emergency guiding system utilizes a portable device to provide evacuation guidance according to the location of the portable device. In comparison with conventional emergency guiding systems which utilize devices immovably disposed at the scene of emergency to provide evacuation guidance, the guidance effect of the emergency guiding system is not liable to be influenced by dense smoke during a fire. In addition, since evacuation guidance are provided according to the location of the portable device and the real time status of the emergency, the emergency guiding system is capable of providing real time and more accurate evacuation guidance to the user of the portable device, while the time and the network bandwidth for transmitting the recommended route is saved by merely transmitting a portion of the recommended route adjacent to the portable device. Furthermore, since the display unit of the portable device merely displays the route chart which is a portion of the recommended route adjacent to the portable device, the user of the portable device can recognize the route to evacuate easily even when in a hurry, while the route chart has a smaller size and is more applicable to a portable device. Hence, the emergency guiding system is especially suitable for larger scenes such as skyscrapers or factory buildings.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An emergency guiding system, comprising:
an emergency guiding server including a guiding scheme determination unit and a route providing unit, wherein the guiding scheme determination unit produces a guiding scheme in response to the current status of an emergency in real time;
a portable device including a short distance wireless communication unit communicating with the emergency guiding server through a wireless network; and
a plurality of short distance wireless identifiers separately disposed in areas corresponding to the emergency, wherein the short distance wireless identifiers detect the presence of the portable device through the short distance wireless communication unit of the portable device, each of the short distance wireless identifiers transmits a location signal to the emergency guiding server in response to detecting the presence of the portable device;
wherein the route providing unit of the emergency guiding server produces a recommended route to reach a particular target according to the last guiding scheme and the location signal in response to the production of the guiding scheme, the emergency guiding server transmits a guiding signal including at least a portion of the recommended route adjacent to the portable device to the portable device according to the location signal, wherein the range of the recommended route transmitted to the portable device is capable of being adjusted according to a route range signal received from the portable device.

2. The system of claim 1, wherein the emergency guiding server determines the current status of the emergency by an alarm signal received from a hazard processing apparatus coupled to a plurality of sensors, the hazard processing apparatus transmits the alarm signal including status information of the actuated sensors to the emergency guiding server in response to detecting the current status of the emergency through the sensors.

3. The system of claim 2, wherein the guiding scheme determination unit of the emergency guiding server includes a guiding scheme database including a plurality of predetermined guiding schemes corresponding to the sensors, the guiding scheme determination unit chooses one of the predetermined guiding schemes as the guiding scheme according to the status information of the actuated sensors in the alarm signal.

4. The system of claim 1, wherein the emergency guiding server transmits the guiding signal to the portable device through the wireless network.

5. The system of claim 1, wherein each of the short distance wireless identifiers includes a Bluetooth receiver, the short distance wireless communication unit of the portable device includes a Bluetooth transmitter.

6. The system of claim 1, wherein each of the short distance wireless identifiers includes a RFID (radio-frequency identification) reader, the short distance wireless communication unit of the portable device includes a RFID tag.

7. The system of claim 1, wherein each of the short distance wireless identifiers includes a near field communication (NFC) receiver, the short distance wireless communication unit of the portable device includes a NFC transmitter.

8. The system of claim 1, wherein the location signal includes a location of the portable device or the short distance wireless identifier.

9. The system of claim 1, wherein the portable device further includes a display unit, the portable device provides a route chart according to the recommended route in the guiding signal through the display unit.

10. The system of claim 9, wherein the route chart automatically rotates corresponding to the direction of the portable device.

11. The system of claim 9, wherein the direction of the route chart is fixed to a particular direction corresponding to the scene of the emergency.

12. The system of claim 1, wherein the portable device further includes a speaker unit, the portable device provides an audio guidance according to the recommended route in the guiding signal through the speaker unit.

13. The system of claim 12, wherein the audio guidance is provided through a phone call.

14. The system of claim 1, wherein the portable device further includes a direction identification unit determining a direction of the portable device.

15. The system of claim 1, wherein the portable device further includes an actuating unit, the emergency guiding server transmits a triggering signal to the portable device in response to the emergency, the actuating unit automatically enables the short distance wireless communication unit in response to the triggering signal.

16. An emergency guiding server, comprising:
a guiding scheme determination unit producing a guiding scheme in response to the current status of an emergency in real time; and
a route providing unit, wherein the route providing unit produces a recommended route to reach a particular target in response to the production of the guiding scheme, the recommended route is produced according to the last guiding scheme and a location signal representing the presence of a portable device received from a short distance wireless identifier disposed in an area corresponding to the emergency, and the emergency guiding server transmits a guiding signal including at least a portion of the recommended route adjacent to the portable device to the portable device according to the location signal, wherein the range of the recommended route transmitted to the portable device is capable of being adjusted according to a route range signal received from the portable device.

17. The server of claim 16, wherein the emergency guiding server determines the current status of the emergency by an alarm signal received from a hazard processing apparatus coupled to a plurality of sensors, the hazard processing apparatus transmits the alarm signal including status information of the actuated sensors to the emergency guiding server in response to detecting the current status of the emergency through the sensors.

18. The server of claim 17, wherein the guiding scheme determination unit includes a guiding scheme database including a plurality of predetermined guiding schemes corresponding to the sensors, the guiding scheme determination unit chooses one of the predetermined guiding schemes as the guiding scheme according to the status information of the actuated sensors in the alarm signal.

19. The server of claim 16, wherein the emergency guiding server transmits the guiding signal to the portable device through a wireless network.

20. The server of claim 16, wherein the emergency guiding server transmits a triggering signal to the portable device to enable an actuating unit of the portable device to enable communication between the portable device and the short distance wireless identifier.
